(19) United States
(12) Patent Application Publication
(10) Pub. No.: US 2015/0217560 A1
(43) Pub. Date: Aug. 6, 2015

(54) BLANKET SET, TRANSFER ROLL, AND PRINTING APPARATUS

(71) Applicant: Jun SAKAMOTO, Osaka (JP)

(72) Inventors: Jun Sakamoto, Osaka-shi (JP); Koji Sakamoto, Osaka-shi (JP)

(21) Appl. No.: 14/401,682

(22) PCT Filed: May 18, 2012
(86) PCT No.: PCT/JP2012/062786

§ 371 Date: Apr. 6, 2015

(51) Int. Cl. B41F 13/193

(52) U.S. Cl. CPC B41F 13/193

(57) ABSTRACT

[Solution] A blanket set (10) according to the present invention includes a base (12) having an inner peripheral surface (12s) and an outer peripheral surface (12t) and including a plurality of base portions (12a) each having an inner peripheral surface (12as) and an outer peripheral surface (12at) and at least one blanket (14) provided on the outer peripheral surface (12at) of at least one base portion (12a) of the plurality of base portions (12a). Preferably, the at least one base portion (12a) and the at least one blanket (14) are integrally removable.

### TECHNICAL FIELD

The present invention relates to blanket sets, transfer rolls, and printing apparatuses.

### BACKGROUND ART

Offset printing has been known as one of printing techniques. The offset printing is performed in a manner that ink is transferred from a pattern roll to a blanket of a transfer roll, and the transfer roll then prints the ink onto a to-be-printed object. The pattern roll and the transfer roll are mounted rotatably about respective shafts. In the offset printing, a print pattern of the pattern roll can be printed on the surface of the to-be-printed object with excellent reproducibility (see Patent Document 1, for example).

Patent Document 1 discloses a printing apparatus including a plurality of printing machines. The plurality of printing machines of the printing apparatus in Patent Document 1 are arrayed in one row and individually print ink onto a to-be-printed object that is being conveyed.

### PRIOR ART REFERENCE

### Patent Document

[Patent Document 1] Japanese Patent Application Laid-Open Publication No. 2008-168578

### SUMMARY OF THE INVENTION

### Technical Problems

When the blanket of the transfer roll is worn and degraded, the blanket must be replaced. However, replacement of the blanket is not so easy because it is necessary to remove the transfer roll from the shaft first, to remove the blanket of the transfer roll, and then, to set a new blanket.

Further, offset printing on conveyed to-be-printed object can be performed appropriately on a flat surface but may be performed inappropriately on a recessed surface. For example, in printing the recessed surface, a portion of the transfer roll that is other than a printing surface may come in contact with the recessed surface.

The present invention has its object of providing a blanket set, a transfer roll, and a printing apparatus that can facilitate replacement of a blanket. Another object of the present invention is to provide a blanket set, a transfer roll, and a printing apparatus that are suitable for printing on a recessed surface of a to-be-printed object

### Solution to Problems

A blanket set according to the present invention includes: a base having an inner peripheral surface and an outer peripheral surface and including a plurality of base portions each having an inner peripheral surface and an outer peripheral surface; and at least one blanket provided on the outer peripheral surface of at least one base portion of the plurality of base portions.

In one embodiment, the at least one base portion and the at least one blanket are integrally removable.

In one embodiment, the inner peripheral surface of the at least one base portion corresponds to a part of an outer peripheral surface in a columnar or cylindrical shape, and the inner peripheral surface of the at least one base portion has a central angle of 180 degrees or smaller.

In one embodiment, the at least one blanket includes a plurality of blankets individually corresponding to the plurality of base portions.

In one embodiment, the at least one blanket is bonded to the at least one base portion using a coupling agent.

In one embodiment, a step is formed on at least one of the outer peripheral surface of the at least one base portion and a surface of the at least one blanket.

In one embodiment, the step is formed on the outer peripheral surface of the at least one base portion.

In one embodiment, the base is almost constant in thickness.

A transfer roll according to the present invention includes the above blanket set; and a core having an outer peripheral surface corresponding to the inner peripheral surface of the base of the blanket set.

In one embodiment, a through hole is formed in the at least one base portion, and the blanket set is fixed to the core by means of a fixing member provided in the through hole.

In one embodiment, a protrusion is formed on one of the inner peripheral surface of the base and the outer peripheral surface of the core, while a recess corresponding to the protrusion is formed in the other.

In one embodiment, a step is formed on at least one of the outer peripheral surface of the core, the outer peripheral surface of the base portion, and a surface of the blanket.

A printing apparatus according to the present invention includes the above transfer roll; and a pattern roll.

In one embodiment, the transfer roll and the pattern roll are columnar or cylindrical in shape, and the transfer roll has a diameter that is an integral multiple of a diameter of the pattern roll.

A transfer roll according to the present invention includes a core having an outer peripheral surface, a base having an inner peripheral surface corresponding to the outer peripheral surface of the core and an outer peripheral surface, and a blanket provided on the outer peripheral surface of the base. A step is formed on at least one of the outer peripheral surface of the core, the outer peripheral surface of the base, and the surface of the blanket.

A transfer roll according to the present invention includes a core having an outer peripheral surface and a blanket provided on the outer peripheral surface of the care. A step is formed on at least one of the outer peripheral surface of the core and the surface of the blanket.

A printing apparatus according to the present invention includes the above transfer roll, a pattern roll, and a conveyer.

### Advantages of the Invention

According to the present invention, replacement of the blanket can be facilitated. Further, according to the present invention, printing on a recessed surface can be performed suitably.

### BRIEF DESCRIPTION OF THE DRAWINGS

FIG. 1 is a schematic diagram of a blanket set according to an embodiment of the present invention.

FIG. 2A is a schematic diagram of a transfer roll including the blanket set shown in FIG. 1, and FIG. 2B is a schematic perspective view of the transfer roll.

FIG. 3 is a schematic diagram of a printing machine including the transfer roll shown in FIG. 2.

FIG. 4 is a schematic diagram of a printing apparatus including the printing machine shown in FIG. 3.

FIG. 5 is a schematic cross sectional view of a blanket set according to an embodiment of the present invention.

FIG. 6 is a schematic diagram of a blanket set according to an embodiment of the present invention.

FIG. 7 is a schematic diagram of a blanket set according to an embodiment of the present invention.

FIG. 8A is a schematic diagram of a blanket set according to an embodiment of the present invention, and FIG. 8B is a schematic diagram of a transfer roll including the blanket set shown in FIG. 8A.

FIG. 9 is a schematic diagram of a printing machine including the transfer roll shown in FIG. 8B.

FIG. 10 is a schematic diagram of a printing apparatus including the printing machine shown in FIG. 9.

FIG. 11 is a schematic diagram of a printed object printed by the printing machine shown in FIG. 9.

FIG. 12 is a schematic diagram of a printed object printed by the printing machine shown in FIG. 9.

FIG. 13 is a schematic diagram of a printing machine according to an embodiment of the present invention.

FIG. 14 is a schematic cross sectional view of a blanket set according to an embodiment of the present invention.

FIG. 15 is a schematic top view of the blanket set shown in FIG. 14.

FIG. 16A is a schematic side view of a blanket set according to an embodiment of the present invention, and FIG. 16B is a schematic top view of FIG. 16A.

FIG. 17 is a schematic partially exploded view of a blanket set according to an embodiment of the present invention.

FIG. 18 is a schematic diagram of a transfer roll according to an embodiment of the present invention.

FIG. 19 is a schematic diagram of a transfer roll according to an embodiment of the present invention.

FIG. 20 is a schematic diagram of a printing apparatus including transfer rolls according to the embodiment.

FIG. 21 is a schematic diagram of a transfer roll according to an embodiment of the present invention.

FIG. 22 is a schematic diagram of a transfer roll according to an embodiment of the present invention.

FIG. 23 is a schematic diagram of a transfer roll according to an embodiment of the present invention.

FIG. 24 is a schematic diagram of a transfer roll according to an embodiment of the present invention.

FIG. 25 is a schematic diagram of a transfer roll according to an embodiment of the present invention.

FIG. 26 is a schematic diagram of a transfer roll according to an embodiment of the present invention.

FIG. 27 is a schematic diagram of a transfer roll according to an embodiment of the present invention.

FIG. 28 is a schematic diagram of a transfer roll according to an embodiment of the present invention.

### MODE FOR CARRYING OUT THE INVENTION

Embodiments of a blanket set, a transfer roll, and a printing apparatus according to the present invention will be described below with reference to the accompanying drawings.

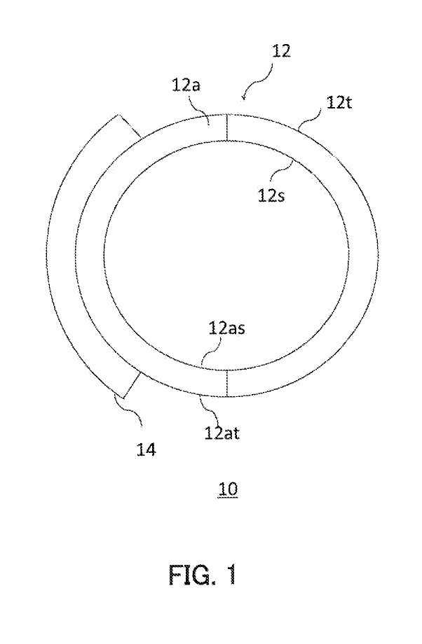

FIG. 1 is a schematic diagram showing a blanket set 10 of the present embodiment. The blanket set 10 includes a base 12 and a blanket 14. As will be described later, the blanket set 10 is mounted to a core to rotate together with the core.

The blanket 14 is comparatively soft, while the base 12 is harder than the blanket 14. The blanket 14 is made of rubber, for example. Specifically, the blanket 14 may be made of silicone rubber. The base 12 is made of steel or aluminum, for example.

The base 12 has an inner peripheral surface 12s and an outer peripheral surface 12t. For example, the base 12 is cylindrical in shape. The inner peripheral surface 12s of the base 12 is shaped to correspond to an outer peripheral surface in a column or cylinder. The blanket set 10 rotates about the central axis of the column or cylinder as a center of rotation.

The base 12 includes a plurality of base portions 12a. Here, the base portions 12a adjacent to each other are in contact with each other and are separable from each other. The base 12 of the blanket set 10 shown in FIG. 1 includes two base portions 12a. Each of the base portions 12a is in a half-cylindrical shape and has an inner peripheral surface 12as and an outer peripheral surface 12at. For example, the base portions 12a are manufactured using a mold.

The blanket 14 is provided on the outer peripheral surface 12at of at least one of the plurality of base portions 12a. The blanket 14 herein is provided on the outer peripheral surface 12at of one of the two base portions 12a. The blanket 14 has a thickness of 6 mm or more, for example.

The blanket 14 of the blanket set 10 is provided so as to cover a part of the outer peripheral surface 12at of the one base portion 12a and not to cover the boundaries between the base portions 12a adjacent to each other. In the blanket set 10, the base portion 12a and the blanket 14 can be handled together solidly.

For example, the blanket set 10 is manufactured as follows. In one example, the blanket set 10 is assembled by attaching the blanket 14 cut out into a predetermined shape to the outer peripheral surface 12at of the one base portion 12a. In this case, the blanket 14 is preferably made of a material having high adhesiveness to the base 12.

Alternatively, a base portion 12a is set in a mold, and then, a blanket material (e.g., rubber) is filled into a predetermined space in the mold to form the blanket 14. In this case, the blanket 14 is integrally formed with the base portion 12a. It is noted that the blanket material is preferably filled under a vacuum condition. Further, where the blanket 14 is made of silicone rubber, a coupling agent may be applied onto the outer peripheral surface 12at of the base portion 12a prior to formation of the blanket 14. Application of the coupling agent onto the outer peripheral surface 12a of the base portion 12a can reform the outer peripheral surface 12at of the base portion 12a to improve adhesiveness of the blanket 14 to the base portion 12a.

Alternatively, the base portion 12a and the blanket 14 may be bonded together using a bonding agent after they are manufactured individually. However, in this case, air or foreign matter may intervene at the interface between the base portion 12a and the blanket 14, thereby causing roughness on the surface of the blanket 14. For this reason, it is preferable to bond the blanket 14 to the base portion 12a using a coupling agent, as described above.

The blanket 14 of the blanket set 10 according to the present embodiment is provided on the outer peripheral surface 12at of the base portion 12a. Accordingly, replacement of the blanket 14 can be easily done by removing the blanket 14 and the corresponding base portion 12a together and mounting a new blanket 14 and the corresponding base portion 12a. Further, the blanket 14 is provided on a part of the outer peripheral surface 12t of the base 12 rather than surrounds the entirety of the outer peripheral surface 12t of the base 12. This can reduce the amount of use of the blanket material.

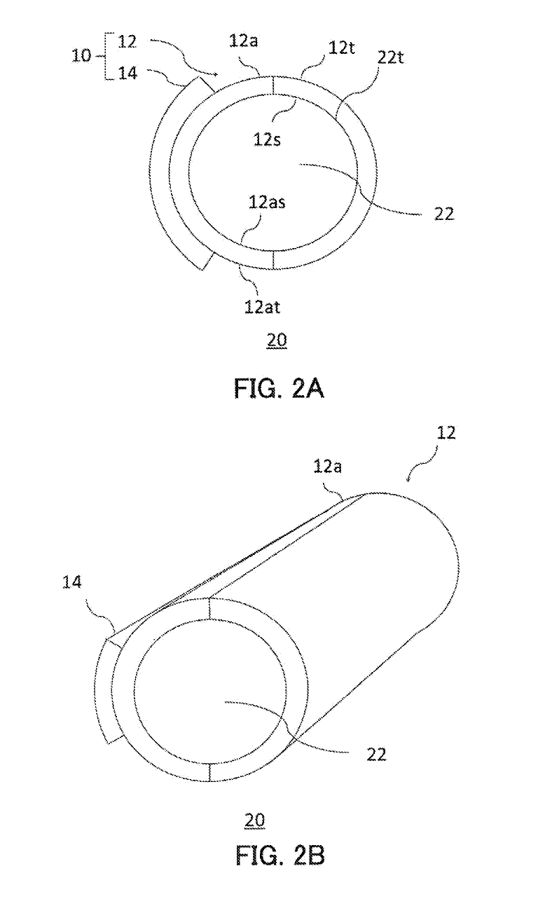

A transfer roll 20 of the present embodiment will now be described with reference to FIG. 2. FIG. 2A is a schematic side view of the transfer roll 20. FIG. 2B is a schematic perspective view of the transfer roll 20.

The transfer roll 20 includes the blanket set 10 and a core 22. For example, the core 22 is made of iron, aluminum, or plastic that has high strength (e.g., thermosetting resin, one example of which is Bakelite). For example, the core 22 includes cylindrical shafts (not shown) extending from the respective two bottom surfaces (flat surfaces) of the core 22. The transfer roll 20 rotates together with the shafts, which are held at their opposite ends. Alternatively, the core 22 may be in a cylindrical shape, and the transfer roll 20 may include a shaft (not shown) mounted on the inner peripheral surface of the core 22 to rotate together with the shaft. Here, the base 12 and the blanket 14 have almost constant thicknesses in a cross section perpendicular to the axis of rotation. Also, the radius of the core 22 is almost constant.

The outer peripheral surface 22t of the core 22 corresponds to the inner peripheral surface 12s of the base 12 of the blanket set 10. Both the inner peripheral surface 12s of the base 12 and the outer peripheral surface 22t of the core 22 are preferably smooth surfaces with less roughness. As needed, the inner peripheral surface 12s of the base 12 may be polished, and the outer peripheral surface 22t of the core 22 may be polished also. The transfer roll 20 has a configuration in which the blanket set 10 can be easily removed from the core 22, thereby enabling easy replacement of the blanket 14 upon being worn and degraded by use.

Attention will now be directed to each central angle of the base portions 12s and the blanket 14 (each central angle of the base portions 12s and the blanket 14 when viewing a cross section perpendicular to the direction of the axis of rotation from a direction parallel to the axis of rotation). In each base portion 12a, the central angle of the inner peripheral surface 12as is approximately equal to the central angle of the outer peripheral surface 12at. Each base portion 12a has a shape obtained by separating a cylinder so as to pass through its central axis. Here, the respective central angles corresponding to the inner peripheral surfaces 12as of the two base portions 12a are 180°. When the central angles corresponding to the inner peripheral surfaces 12as of the base portions 12a are equal to or smaller than 180° as above, replacement of the blanket 14 can further be facilitated. Here, the central angle corresponding to the blanket 14 is smaller than the central angles corresponding to the base portions 12a. Further, it is preferable that the plural base portions 12a are arranged in an almost symmetrical manner when viewing a perpendicular cross section from a direction parallel to the direction of the axis of rotation. This can increase stability of rotation of the transfer roll 20.

The blanket 14 is provided on a part of the outer peripheral surface 12at of a base portion 12a in the blanket set 10. This can reduce the amount of use of a blanket material. Especially, when a to-be-printed area is smaller when compared with the area of the outer peripheral surface of the transfer roll 20, an unnecessary part of the blanket can be reduced, thereby achieving efficient printing.

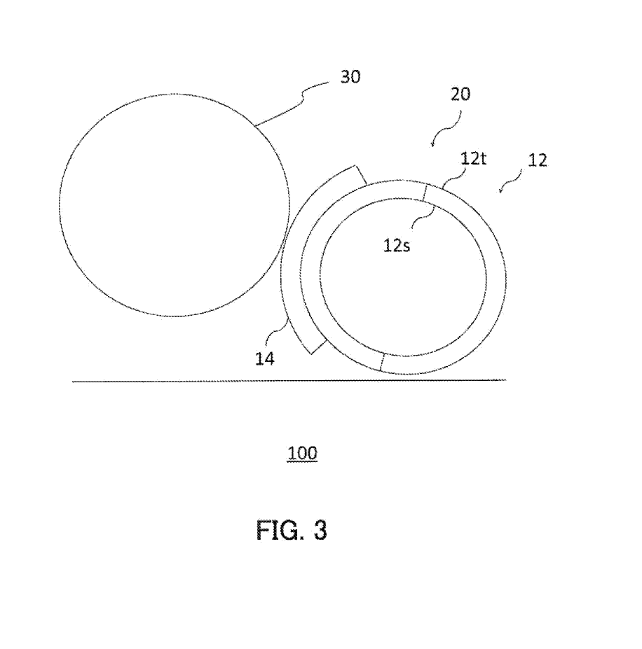

FIG. 3 is a schematic diagram showing a printing machine 100 including the transfer roll 20. The printing machine 100 includes the transfer roll 20 and a pattern roll 30. Both the transfer roll 20 and the pattern roll 30 are mounted rotatably. For example, the transfer roll 20 and the pattern roll 30 each are in a columnar or cylindrical shape, and the pattern roll 30 are provided near the transfer roll 20 so as to be substantially in external contact with the transfer roll 20.

The surface of the pattern roll 30 is subjected to metal plating. In general, grooves are formed into a predetermined pattern in the pattern roll 30. This pattern corresponds to a line, a figure, a motif, etc. that is to be printed on a to-be-printed object (not shown in FIG. 3).

It is noted that the diameter of the transfer roll 20 is approximately equal to that of the pattern roll 30 in FIG. 3, but may be different from that of the pattern roll 30. For example, the diameter of the transfer roll 20 may be larger than that of the pattern roll 30. In this case, it is preferable that the diameter of the transfer roll 20 is approximately an integral multiple of the diameter of the pattern roll 30.

The pattern roll 30 transfers ink (not shown) supplied from the outside to the transfer roll 20. Then, the transfer roll 20 prints the ink onto a to-be-printed object. It is noted that the ink corresponds to the pattern formed in the pattern roll 30. Thereafter, the ink is heated generally. This printing is called offset printing also.

In the printing machine 100, the blanket 14 is provided on a part of the outer peripheral surface 12t of the base 12, so that the radius of the transfer roll 20 varies according to the directions from its center of rotation. Specifically, the distance from the axis of rotation to the surface of the blanket 14 is longer than the distance from the axis of rotation to the outer peripheral surface 12t of the base 12 where no blanket 14 is provided. Accordingly, the printing machine 100 can perform printing even when the printing surface of a to-be-printed object is a recessed surface. It is noted that with large difference between the above distances, printing can be appropriately performed even when such a recessed surface of a to-be-printed object is considerably deep.

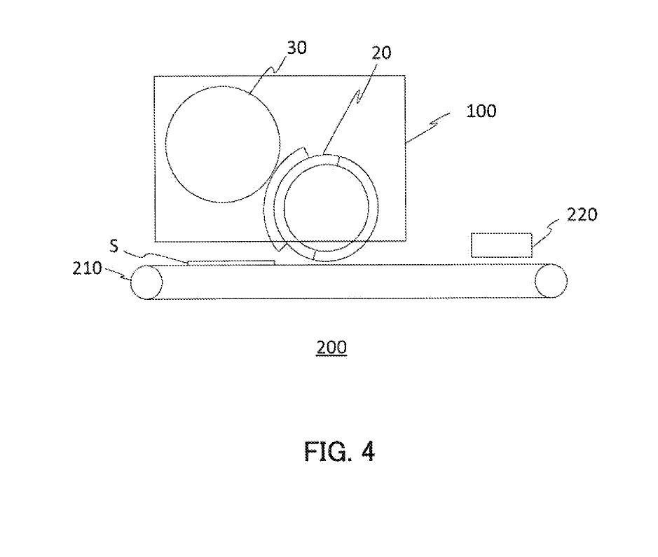

FIG. 4 is a schematic diagram showing a printing apparatus 200 including the printing machine 100. The printing apparatus 200 includes the printing machine 100 and a conveyer 210 that conveys a to-be-printed object S. The printing apparatus 200 may further include a heater 220.

First, the to-be-printed object S is placed on the conveyer 210 that is rotating. The conveyer 210 conveys the to-be-printed object S. When the to-be-printed object S conveyed by the conveyer 210 comes under the printing machine 100, the printing machine 100 prints ink onto the to-be-printed object S.

Subsequently, the conveyer 210 conveys to the heater 220 the to-be-printed object S on which the ink is printed. The to-be-printed object S is heated in the heater 220, thereby baking the ink.

It is noted that the ink may be generally called printing ink for reproduction of a letter, an image, etc. Alternatively, the ink may be ink containing a conductive material. In this case, electronic devices can be favorably manufactured using the printing apparatus 200.

In the above printing apparatus 200, the to-be-printed object S is moved relative to the printing machine 100 that is fixed, which however, should not be taken to limit the present invention. The printing machine 100 may be moved relative to the to-be-printed object S that is fixed. As such, the to-be-printed object S and the printing machine 100 are moved relatively. Such a printing apparatus 200 is suitable for high-speed printing.

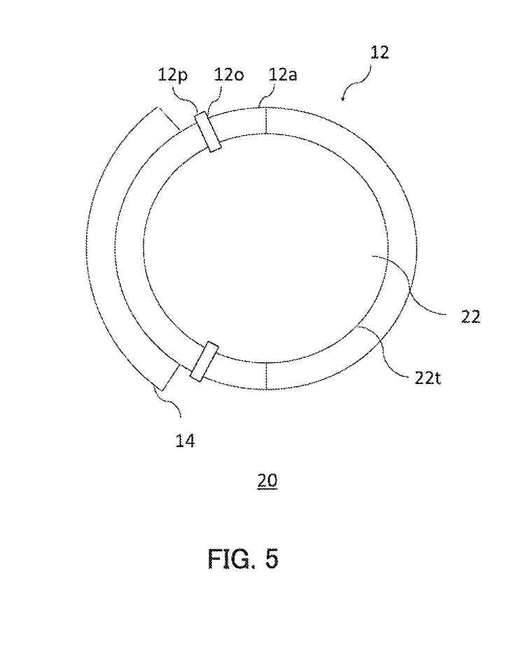

It is noted that the blanket set 10 may be fixed to the core 22 by means of a fixing member. As shown in FIG. 5, through holes 12o are formed in a base portion 12a of the transfer roll 20. Fixing members 12p provided in the through holes 12o fix the blanket set 10 to the core 22. For example, the outer peripheral surface 22t of the core 22 may be threaded to fix the blanket set 10 with a screw.

The present invention is not limited to the above description in which the blanket 14 of the blanket set 10 is provided on a part of the outer peripheral surface 12at of a base portion 12a, and the central angle corresponding to the blanket 14 is smaller than the central angle corresponding to the base portion 12a.

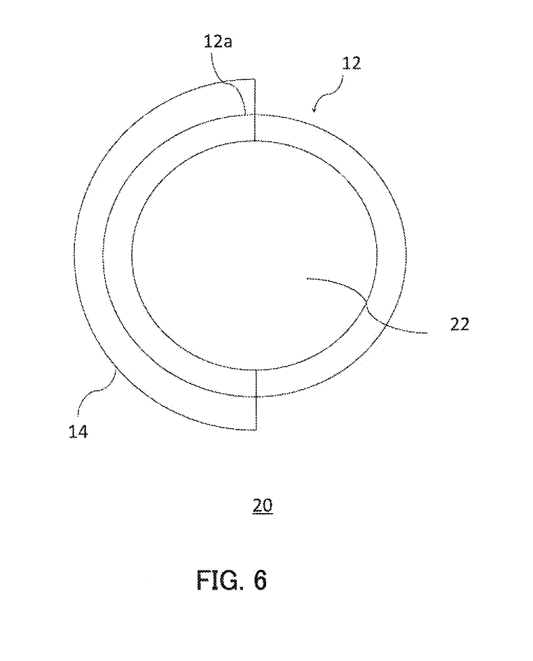

As shown in FIG. 6, the blanket 14 may be provided on the entirety of the outer peripheral surface 12at of a base portion 12a when viewing a cross section perpendicular to the direction of the axis of rotation. In this case, the central angle corresponding to the blanket 14 is equal to that corresponding to the base portion 12a.

The present invention is not limited to the above description in which the base 12 of the blanket set 10 is separable into the two base portions 12a, and the central angles corresponding to the inner peripheral surfaces 12as of the base portions 12a are equal to each other, 180°.

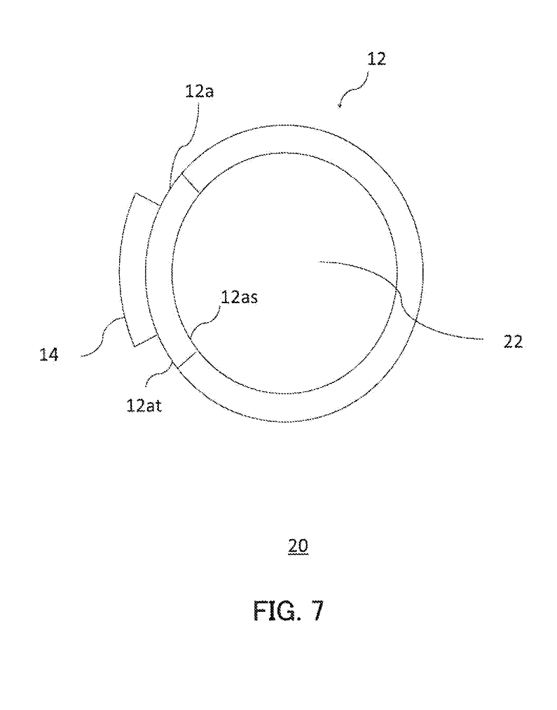

Referring to FIG. 7 showing the transfer roll 20, the central angles corresponding to the inner peripheral surfaces 12as of two base portions 12a may be different from each other. In this case, the blanket 14 is preferably provided on the outer peripheral surface 12at of one of the base portions 12a that has a central angle smaller than 180°. This can further facilitate replacement of the blanket 14. While the central angle corresponding to the base portion 12a corresponding to a blanket 14 that is not to be replaced may exceed 180°, the central angle corresponding to the base portion 12a corresponding to a blanket 14 that is to be replaced is preferably smaller than 180° as above.

The present invention is not limited to the above description in which the single blanket 14 is provided on the outer peripheral surface 12t of the base 12 in the blanket set 10. A plurality of blankets 14 may be provided on the outer peripheral surface 12t of the base 12.

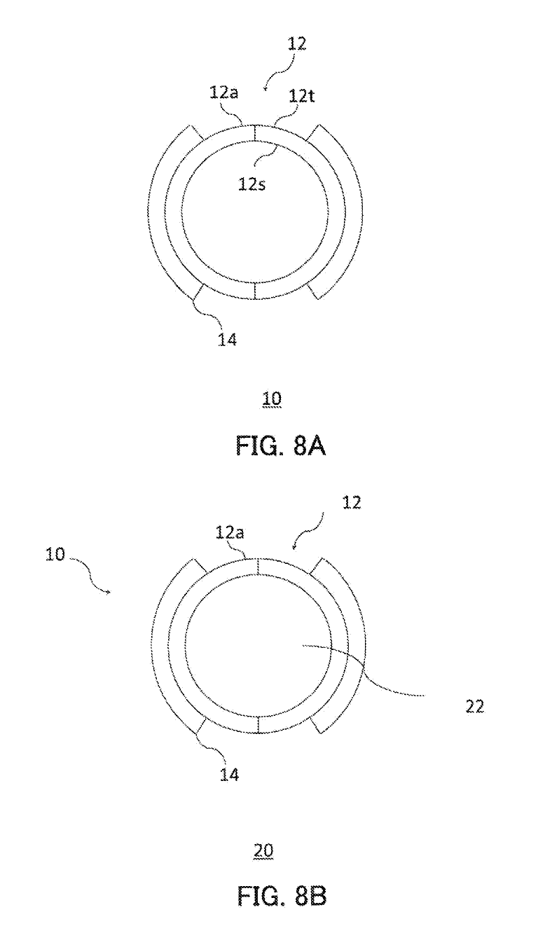

FIG. 8A is a schematic diagram showing a blanket set 10 according to an embodiment. The blanket set 10 has the same configuration as the blanket set 10 described above with reference to FIG. 1, except inclusion of a plurality of blankets 14. Duplication of description is omitted for the purpose of avoiding redundancy. Two blankets 14 are provided in this blanket set 10. Here, the two blankets 14 are provided on the respective outer peripheral surfaces 12at of the two base portions 12a and are separate from each other.

FIG. 8B is a schematic diagram showing a transfer roll 20 including the blanket set 10 shown in FIG. 8A. The transfer roll 20 includes the blanket set 10 and the core 22. The two blankets 14 are provided in the transfer roll 20, thereby enabling two-time printing per one rotation of the transfer roll 20, thereby reducing time required for printing.

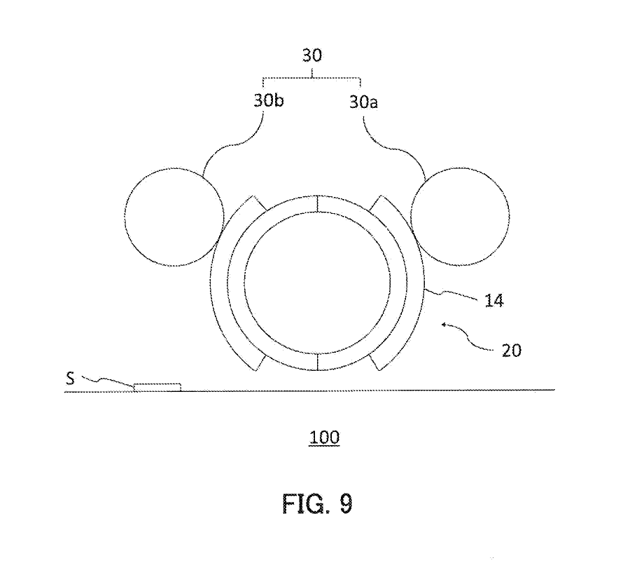

FIG. 9 is a schematic diagram showing a printing machine 100 including the transfer roll 20 shown in FIG. 8B. The printing machine 100 includes the transfer roll 20 and pattern rolls 30a and 30b. Each of the transfer roll 20 and the pattern rolls 30a and 30b are rotatable. The pattern rolls 30a and 30b are provided near the transfer roll 20 so as to be substantially in external contact with the transfer roll 20.

It is noted that the pattern rolls 30a and 30b may have different patterns or almost the same patterns. Where the pattern rolls 30a and 30b have almost the same patterns, adjustment of each rotational speed and phase of the pattern rolls 30a and 30b can result in formation of a layered structure.

Further, in FIG. 9, the diameter of the transfer roll 20 is larger than that of each pattern roll 30a and 30b, may be equal to that of each of the pattern roll 30a and 30b. It is noted that the diameter of the transfer roll 20 is preferably an integral multiple of the respective diameters of the pattern rolls 30a and 3b.

The ratios of the diameter of the transfer roll 20 to the respective diameters of the pattern rolls 30a and 30b are preferably equal to the number of the blankets 14 provided at the transfer roll 20. For example, the diameter of the transfer roll 20 is double each diameter of the pattern rolls 30a and 30b, and two blankets 14 are provided in the blanket set 10. Here, the diameter of the transfer roll 20 is approximately 200 mm, and the diameters of the pattern rolls 30a and 30b are approximately 100 mm.

The printing machine 100 performs printing in the following manner. First, the pattern roll 30a transfers ink (not shown) to one of the blankets 14 of the transfer roll 20. Next, the pattern roll 30b transfers ink (not shown) to the same blanket 14 of the transfer roll 20. For example, the pattern roll 30b transfers the ink so as to layer the ink over at least a part of the previously transferred ink. Subsequently, the transfer roll 20 prints the layered ink onto the to-be-printed object S. It is noted that the individual ink corresponds to the respective patterns formed in the pattern rolls 30a and 30b. Thereafter, the ink is heated generally.

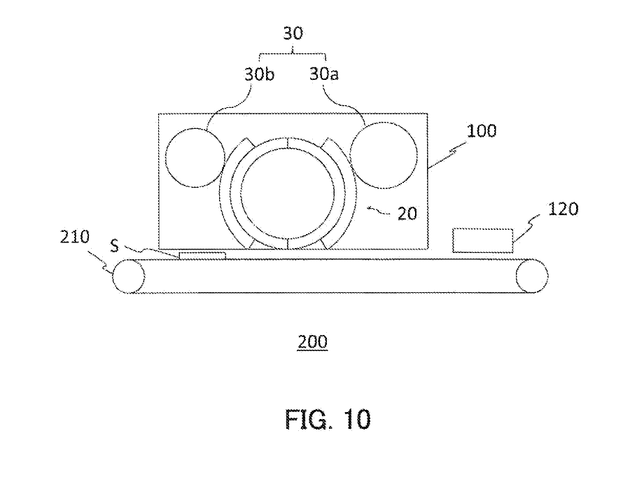

FIG. 10 is a schematic diagram showing a printing apparatus 200 including the printing machine 100. This printing apparatus 200 has the same configuration as the printing apparatus 200 described above with reference to FIG. 4, except the configuration of the transfer roll 20 and inclusion of two pattern rolls 30a and 30b. Duplication of description is therefore omitted for the purpose of avoiding redundancy.

First, a to-be-printed object S is placed on the conveyer 210 that is rotating. The conveyer 210 conveys the to-be-printed object S. When the to-be-printed object S conveyed by the conveyer 210 comes under the printing machine 100, the printing machine 100 prints ink onto the to-be-printed object S.

Then, the conveyer 210 conveys to the heater 220 the to-be-printed object S on which the ink is layered. The to-be-printed object S is heated in the heater 220, thereby baking the ink. Thus, the ink is solidified.

Where the pattern rolls 30a and 30b have almost the same patterns, and the pattern rolls 30a and 30b transfer individual ink containing conductive materials so as to overlay the individual ink, a conductive layered structure can be formed that is comparatively thin and has low resistivity. For example, the pattern rolls 30a and 30b transfer individual ink containing the conductive materials to the transfer roll 20. Examples of the conductive materials include a single substance or a mixture of silver, copper, gold, carbon, cobalt, titanium, nickel, aluminum, etc. It is noted that the conductive materials contained in the individual ink of the pattern rolls 30a and 30b may be the same or different from each other. As such, layering the ink transferred to the transfer roll 20 from the pattern rolls 30a and 30b can result in formation of electrodes having low resistance.

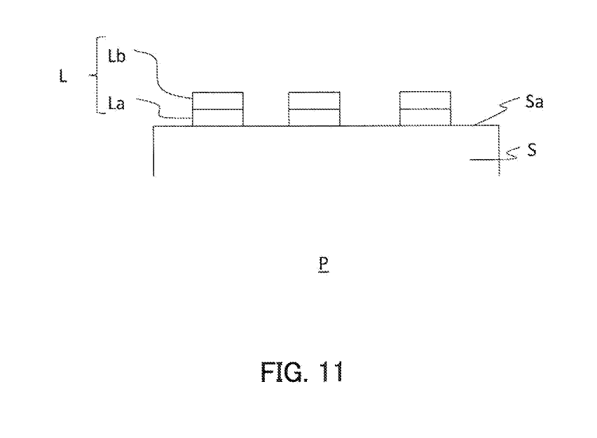

FIG. 11 is a schematic diagram showing a panel P. The panel P includes a to-be-printed object S having a surface Sa and a layered structure L formed on the surface Sa of the to-be-printed object S. Here, the to-be-printed object S is a substrate. The layered structure L forms electrodes having a two-layer structure. Each electrode L includes a conductive layer La in contact with the surface Sa of the substrate S and a conductive layer Lb formed on the conductive layer La. The conductive layer La is formed of ink supplied to the pattern roll 30a, while the conductive layer Lb is formed of ink supplied to the pattern roll 30b. The panel P is suitably used as a solar panel. Alternatively, the panel P may be a touch panel, an electro-magnetic field shield panel, an organic EL panel, etc.

It is noted that the present invention is not limited to the above description in which the layered structure L is formed of the conductive layers. The layered structure may include an insulating layer in addition to a conductive layer. For example, in the printing machine 100 shown in FIG. 9, the pattern roll 30a may transfer ink containing a conductive material, while the pattern roll 30b may transfer ink containing an insulating material. In this case, the pattern formed in the pattern roll 30a is preferably different from the pattern formed in the pattern roll 30b.

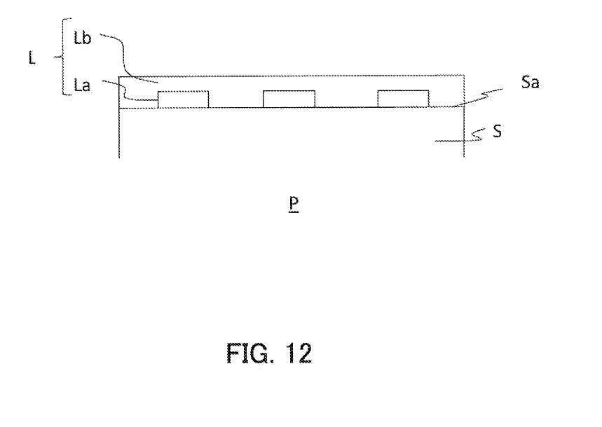

FIG. 12 is a schematic diagram showing a panel P. The panel P includes a substrate S and a layered structure L formed on the surface Sa of the substrate S. Here, the layered structure L includes a conductive layer La in contact with the surface Sa of the substrate S and an insulating layer Lb covering the conductive layer La.

Such the printing machine 100 can be suitably used for manufacture of semiconductor devices. At least one of the plural pattern rolls 30 of the printing machine 100 may transfer ink containing a conductive material. The printing machine 100 can be suitably used for manufacture of transistors.

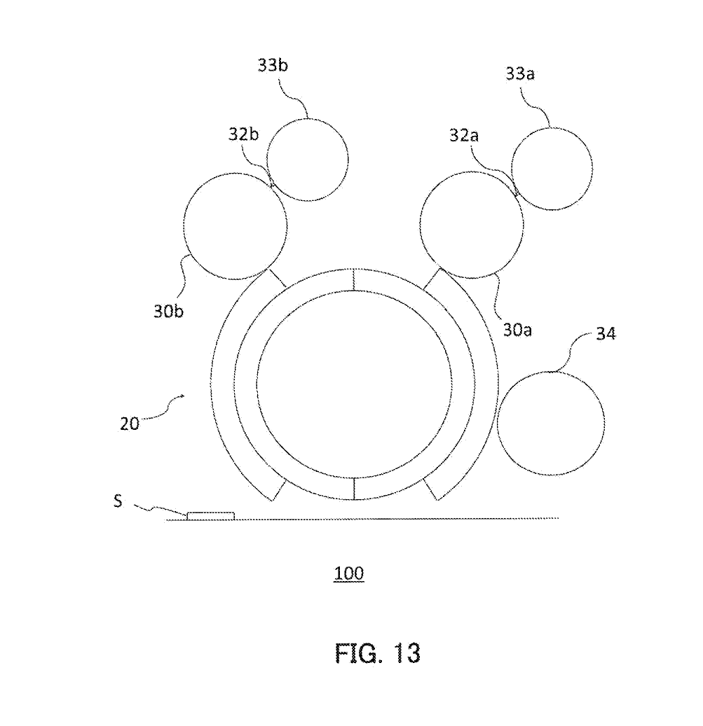

FIG. 13 is a schematic diagram showing a printing machine 100 according to an embodiment. In this printing machine 100, ink (not shown) is dripped from above the pattern rolls 30a and 30b. A scraper 32a is provided near the pattern roll 30a in the printing machine 100 so as to be in contact with the pattern roll 30a. Surplus ink of the ink dripped onto the outer peripheral surface of the pattern roll 30a is removed from the outer peripheral surface of the pattern roll 30a by the scraper 32a. It is noted that the scraper 32a is attached to an air cylinder, and the air cylinder adjusts the pressure of the scraper 32a against the pattern roll 30a. The air cylinder is mounted on a holding member 33a. The holding member 33a is rotatable and slidable through a metal bearing. Sliding the scraper 32a can move a contact region between the pattern roll 30a and the scraper 32a, thereby extending an abrasion time period and reducing occurrence of ink lines. Likewise, a scraper 32b is provided near the pattern roll 30b so as to be in contact with the pattern roll 30b. Also, an air cylinder to adjust the scraper 32b is mounted on a holding member 33b.

The printing machine 100 further includes a cleaning roll 34. With the cleaning roll 34, ink remaining on the transfer roll 20 after the transfer roll 20 performs printing on the to-be-printed object S can be removed. It is noted that the cleaning roll 34 preferably exhibits higher wettability with respect to ink than the transfer roll 20.

It is noted that the ink is supplied by being dripped from above the pattern rolls 30a and 30b herein, which does not limit ink supply. The ink may be supplied from an ink reservoir. Alternatively, the ink may be injected from nozzles toward the pattern rolls.

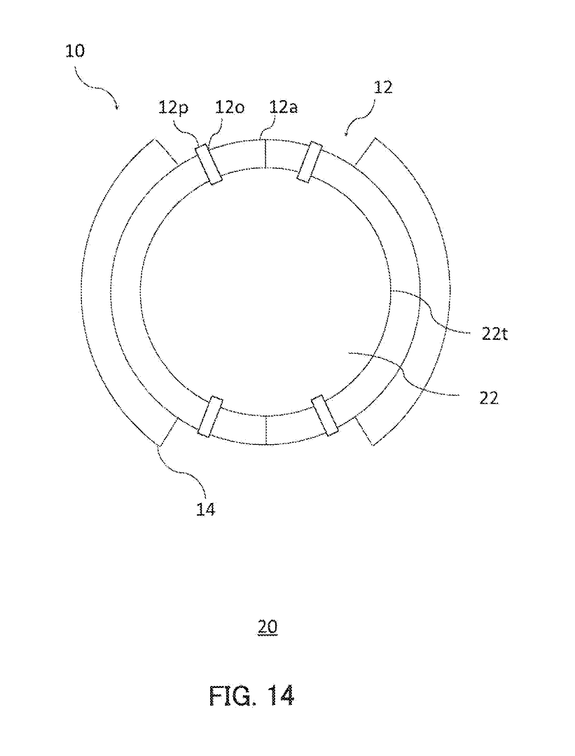

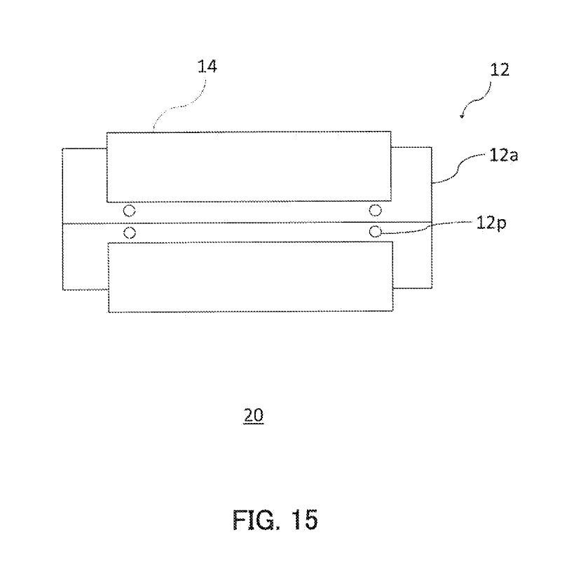

Further, as described above, the blanket set 10 may be fixed to the core 22 by means of a fixing member. FIG. 14 is a schematic cross sectional view of a transfer roll 20, and FIG. 15 is a schematic top view of this transfer roll 20. Through holes 12o are formed in base portions 12a of the transfer roll 20. Provision of fixing members 12p in the through holes 12o results in fixing of blanket set 10 to a core 22. For example, the outer peripheral surface 22t of the core 22 may be threaded to fix the blanket set 10 with screws. In addition, the fixing members 12p are arranged between different blankets 14 herein.

It is noted that the present invention is not limited to the transfer roll 20 shown in FIGS. 14 and 15, in which the blankets 14 are provided on respective parts of the outer peripheral surfaces 12at of the base portions 12a, and the central angles corresponding to the respective blankets 14 are smaller than the central angles corresponding to the respective base portions 12a.

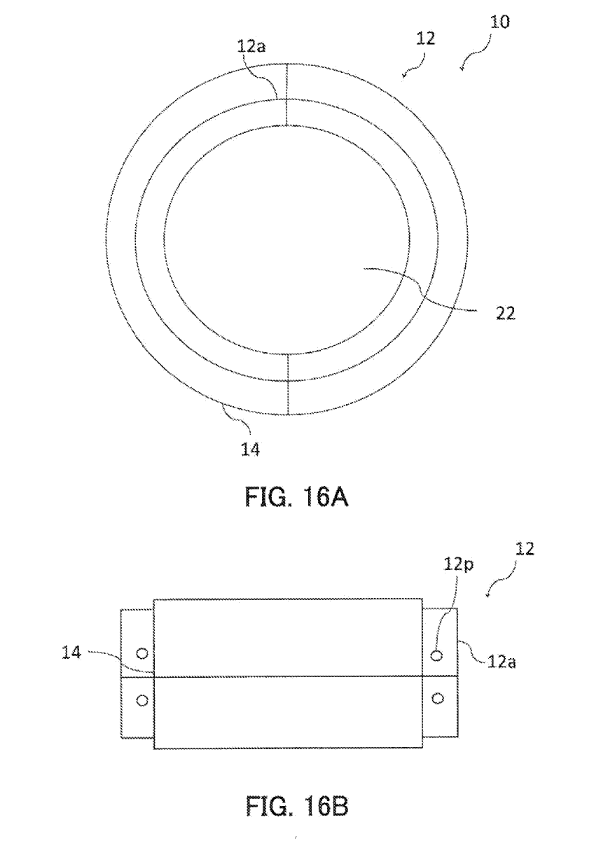

As shown in FIG. 16A, blankets 14 may be provided on the entire outer peripheral surfaces 12at of the base portions 12a when viewing a cross section perpendicular to the direction of the axis of rotation. In this case, the central angles corresponding to the respective blankets 14 are equal to the central angles corresponding to the respective base portions 12a. Further, in this case, the fixing members 12p are arranged on the opposite sides in the direction of the axis of rotation of the blankets 14, as shown in FIG. 16B.

It is noted that in order to reduce displacement in mounting the blanket set 10 onto the core 22 and in using the transfer roll 20, a protrusion may be formed on one of the inner peripheral surface 12s of the base 12 and the outer peripheral surface 22t of the core 22, while a recess corresponding to the protrusion is formed in the other.

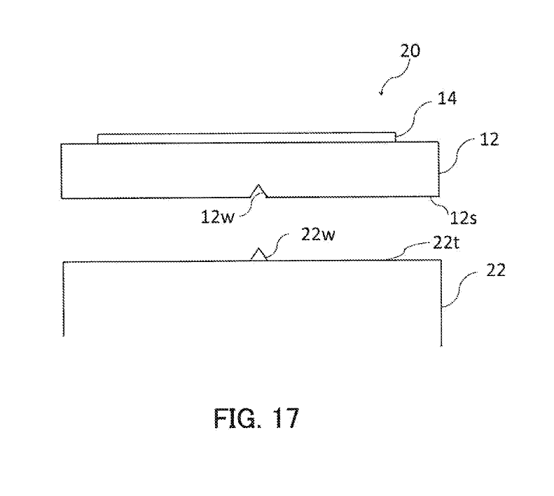

One example of a transfer roll 20 will be described below with reference to FIG. 17, in which a protrusion and a recess are formed on the inner peripheral surface 12s of the base 12 and in the outer peripheral surface 22t of the core 22, respectively. FIG. 17 is a schematic partially exploded view of the interface portion between a core 22 and a blanket set 10 of a transfer roll 20. The axis of rotation of the transfer roll 20 shown in FIG. 17 is parallel to the paper.

In the transfer roll 20, a protrusion 22w is formed on the outer peripheral surface 22t of the core 22, while a recess 12w is formed in the inner peripheral surface 12s of the base 12. The protrusion 22w on the outer peripheral surface 22t of the core 22 and the recess 12w in the inner peripheral surface 12s of the base 12 are substantially the same in size and have shapes corresponding to each other. This can reduce displacement between the blanket set 10 and the core 22. For example, the protrusion 22w on the outer peripheral surface 22t of the core 22 may be formed by shaving a columnar or cylindrical member using a lathe so as to leave a protrusion.

It is noted that the protrusion 22w on the outer peripheral surface 22t of the core 22 and the recess 12w in the inner peripheral surface 12s of the base 12 may be formed in a punctiform manner. In this case, the protrusion 22w and the recess 12w may include a plurality of protrusions on the outer peripheral surface 22t and a plurality of recesses in the inner peripheral surface 12s, respectively.

Alternatively, the protrusion 22w on the outer peripheral surface 22t of the core 22 and the recess 12w in the inner peripheral surface 12s of the base 12 may be formed linearly. Such a recess in the inner peripheral surface 12s of the base 12 may also be called a guide groove. Where the protrusion 22w and the recess 12w are formed in the direction of rotation of the transfer roll 20, printing displacement can be reduced that may occur in a direction orthogonal to a direction in which a to-be-printed object is to be conveyed.

It is noted that the present invention is not limited to the above description in which the number of the base portions 12a in the blanket set 10 is two. Further, the present invention is not limited to the above description in which the number of the blankets 14 is one or two.

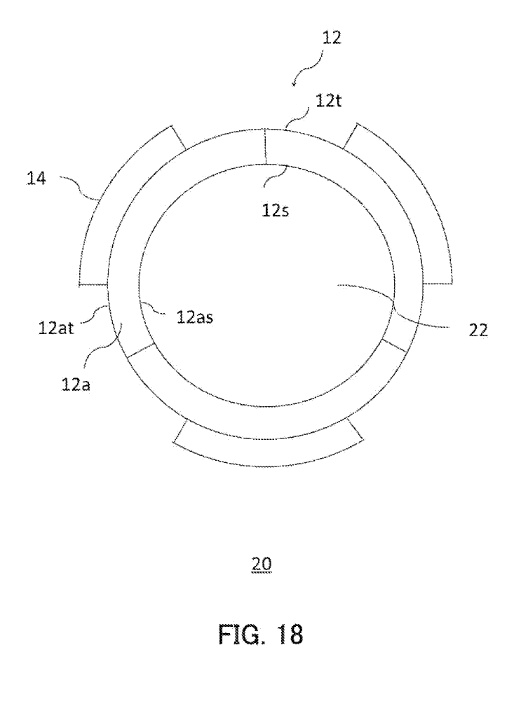

As shown in FIG. 18, the base 12 may include three base portions 12a, and three blankets 14 may be provided on the respective outer peripheral surfaces 12at of the three base portions 12a. It is noted that where such a transfer roll 20 is employed in the printing machine 100 (see FIG. 9), it is preferable that the number of the pattern rolls 30 is equal to that of the blankets 14 and is almost equal to each ratio of the diameter of the transfer roll 20 to the respective diameters of the pattern rolls 30.

Moreover, such the transfer roll 20 is used for manufacture of multilayer ceramic capacitors. A multilayer ceramic capacitor may be manufactured using, for example, a transfer roll 20 shown in FIG. 18. In this case, a first pattern roll 30 transfers ink containing a conductive material to the transfer roll 20, and then, a second pattern roll 30 transfers ink containing an insulating material to the transfer roll 20, followed by transfer of ink containing a conductive ink to the transfer roll 20 by a third pattern roll 30. Thus, the capacitor can be manufactured. Accordingly, the printing machine 100 can be used suitably for manufacture of electronic devices as described above.

Furthermore, the number of the base portions 12a in the blanket set 10 may be four or more, and the number of the blankets 14 may be four or more. One blanket 14 is provided at one base portion 12a at most in the above description. However, a plurality of blankets 14 may be provided at one base portion 12a.

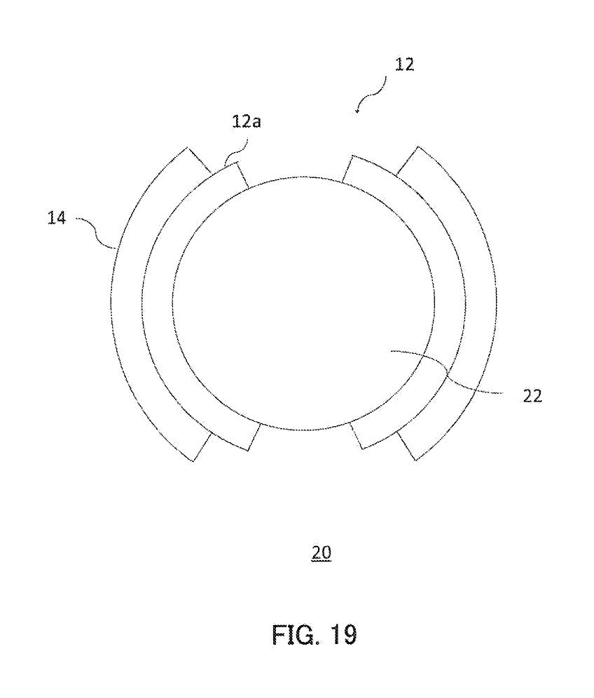

The base portions 12a adjacent to each other are in contact with each other in the above description. However, the present invention is not limited to such a configuration. As shown in FIG. 19, the base portions 12a adjacent to each other may not be in contact with each other. Further, in this case, it is preferable that the plural base portions 12a are arranged in a symmetrical manner when viewing a perpendicular cross section from a direction parallel to the direction of the axis of rotation. This can enhance stability of rotation of the transfer roll 20.

It is noted that the present invention is not limited to the above description in which the printing apparatus 200 includes the single printing machine 100. The printing apparatus 200 may include a plurality of printing machines 100.

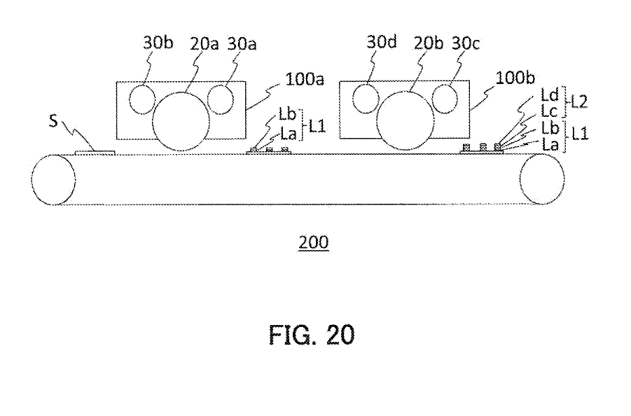

FIG. 20 is a schematic diagram showing a printing apparatus 200 according to an embodiment. The printing apparatus 200 includes two printing machines 100a and 100b. The printing machine 100a transfers a layered structure L1 of conductive layers La and Lb onto a substrate S. The printing machine 100b transfers a layered structure L2 of conductive layers Lc and Ld so that the layered structure L2 overlaps at least a part of the layered structure L1.

The printing machine 100a includes a transfer roll 20a and pattern rolls 30a and 30b. The printing machine 100b includes a transfer roll 20b and pattern rolls 30c, 30d.

The printing machine 100a has the same configuration as the printing machine 100 described above with reference to FIG. 9. In order to avoid redundancy, duplication of description is omitted. Also, the printing machine 100b has the same configuration as the printing machine 100a. In order to avoid redundancy, duplication of description is omitted. The patterns of the pattern rolls 30c, 30d in the printing machine 100 are formed so as to agree with a predetermined form. Further, the conductive materials contained in the conductive layers Lc and Ld may be the same or different from each other. In addition, the conductive materials contained in the conductive layers Lc and Ld may be the same as or different from the conductive materials contained in the conductive layers La and Lb.

The printing apparatus 200 shown in FIG. 20 includes the two printing machines 100a and 100b, but the present invention is not limited to such a configuration. The printing apparatus 200 may include three or more printing machines.

Further, as described above, a blanket 14 is provided on a part of the outer peripheral surface 12t of each base 12, so that the radius of the transfer roll 20 varies according to the directions from the center of rotation. Specifically, the distance from the axis of rotation to the surface of the blanket 14 is longer than the distance from the axis of rotation to the outer peripheral surface 12t of the base 12 where no blanket 14 is provide. With large difference between the distances, appropriate printing can be performed even when the recessed surface of the to-be-printed object S is comparatively deep.

Each of the thicknesses of the base 12 and the blanket 14 and the radius of the core 22 is almost constant in the above description, which however, should not be taken to limit the present invention. A step may be formed on at least one of the outer peripheral surface 12t of the base 12, the surface of the blanket 14, and the outer peripheral surface 22t of the core 22. Formation of the step can further increase the distance from the axis of rotation. This can reduce contact or collision of the blanket 14 and the to-be-printed object S with a portion other than the printing surface even when the recessed surface of the to-be-printed object S is comparatively deep, thereby enabling appropriate printing. It is noted that printing to a recessed surface of the to-be-printed object S may be performed in a state in which the to-be-printed object S is placed on a flattened member having a flat bottom surface, as needed. For example, the to-be-printed object S may be a rear window of an automobile.

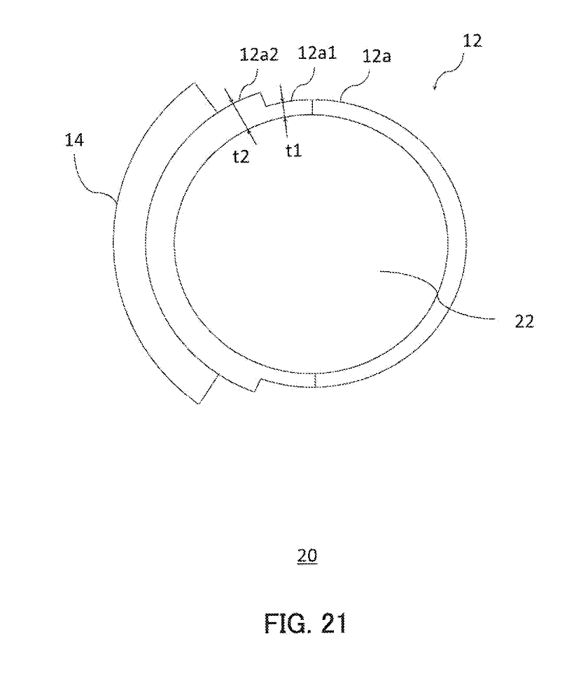

FIG. 21 is a schematic diagram showing a transfer roll 20. Here, the thickness of a blanket 14 and the radius of a core 22 are almost constant, and steps are formed on a base portion 12a on which the blanket 14 provided. Specifically, the base portion 12a includes a region 12a1 having a thickness t1 and a region 12a having a thickness t2 larger than the thickness t1. The thickness herein means a distance between the inner peripheral surface 12as and the outer peripheral surface 12at of the base portion 12a in a cross section perpendicular to the direction of the axis of rotation. FIG. 21 shows that the blanket 14 is provided in the region 12a2 having the thickness t2 larger than the thickness t1. Accordingly, formation of the steps on the base portion 12a can result in appropriate printing even when the recessed surface of the to-be-printed object S is comparatively deep.

FIG. 21 shows the transfer roll 20 in which the steps are formed on the base 12, which however, should not be taken to limit the present invention. The steps may be formed on the core 22.

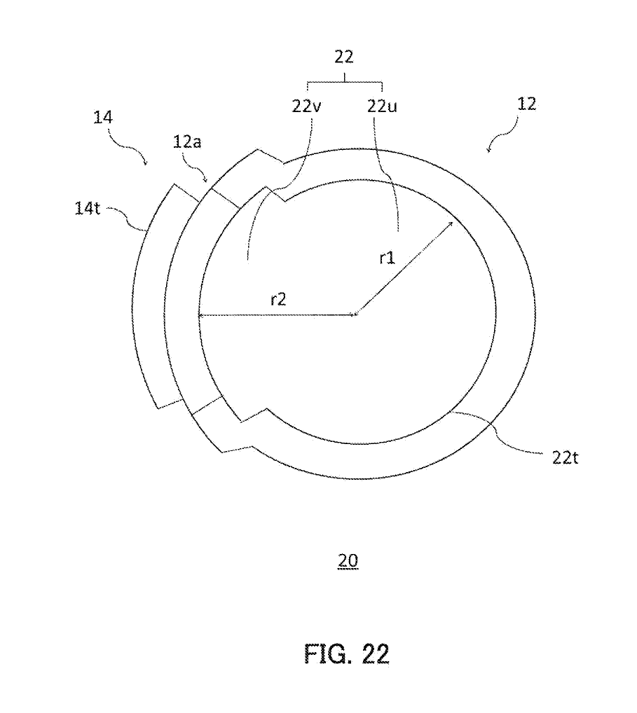

FIG. 22 is a schematic diagram showing a transfer roll 20. Here, the thicknesses of the base 12 and the blanket 14 are almost constant, and steps are formed on the outer peripheral surface 22t of the core 22. Specifically, the core 22 includes a region 22u having a radius r1 and a region 22v having a radius r2 larger than the radius r1. The radius herein means a distance from the center of rotation to the outer peripheral surface 22t of the core 22. In FIG. 22, a blanket 14 is provided in the region 22v having the radius r2 larger than the radius r1 via the base 12. Formation of the steps on the core 22 in such a fashion can result in appropriate printing even when the recessed surface of the to-be-printed object S is comparatively deep. It is noted that in view of replacement of the blanket 14, the central angle corresponding to the base portion 12a at which the blanket 14 is provided is preferably smaller than the central angle corresponding to the region 22v of the core 22.

The steps are formed on the core 22 in the transfer roll 20 shown in FIG. 22, but the present invention is not limited to such a configuration. The steps may be formed on the blanket 14.

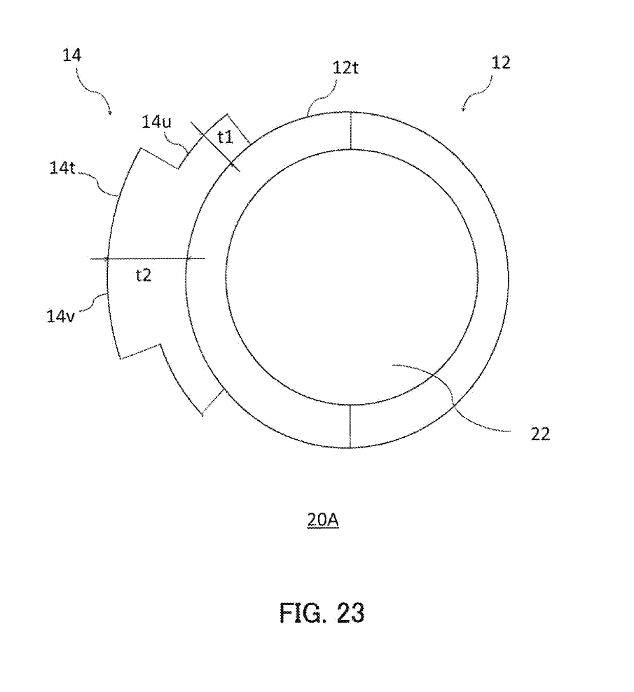

FIG. 23 is a schematic diagram showing a transfer roll 20. Here, the thickness of a base 12 and the radius of a core 22 are almost constant, and steps are formed on the surface 14t of a blanket 14. Specifically, the blanket 14 includes a region 14u having a thickness t1 and a region 14v having a thickness t2 larger than the thickness t1. The thickness herein means a distance between the outer peripheral surface 12t of the base 12 and the surface 14t of the blanket 14 in a cross section perpendicular to the direction of the axis of rotation. Formation of the steps on the blanket 14 in such a fashion can result in appropriate printing even when the recessed surface of the to-be-printed object S is comparatively deep.

It is noted that each base 12 of the transfer rolls 20 shown in FIG. 1 through to FIG. 23 includes a plurality of base portions 12a, which however, should not be taken to limit the present invention. The base 12 may be formed in a solid piece.

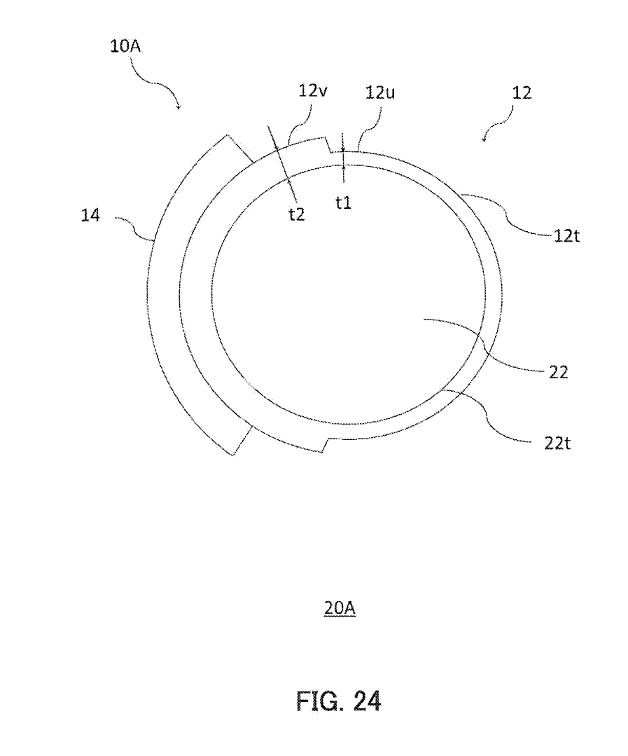

FIG. 24 is a schematic diagram showing a transfer roll 20A. The transfer roll 20A includes a blanket set 10A and a core 22. Here, the blanket set 10A includes a base 12 and a blanket 14. This base 12 is formed in a solid piece so as to surround the outer peripheral surface 22t of the core 22.

In this transfer roll 20A, steps are formed on the outer peripheral surface 12t of the base 12. Specifically, the base 12 includes a region 12u having a thickness t1 and a region 12v having a thickness t2 larger than the thickness 1t. FIG. 24 shows that the blanket 14 is provided in the region 12v having the thickness t2 larger than the thickness t1. Formation of the steps on the base 12 in such a fashion can result in appropriate printing even when the recessed surface of the to-be-printed object S is comparatively deep.

It is noted that the transfer roll 20A shown in FIG. 24 includes the base 12 on which the steps are formed, but the present invention is not limited to such a configuration. The steps may be formed on the core 22.

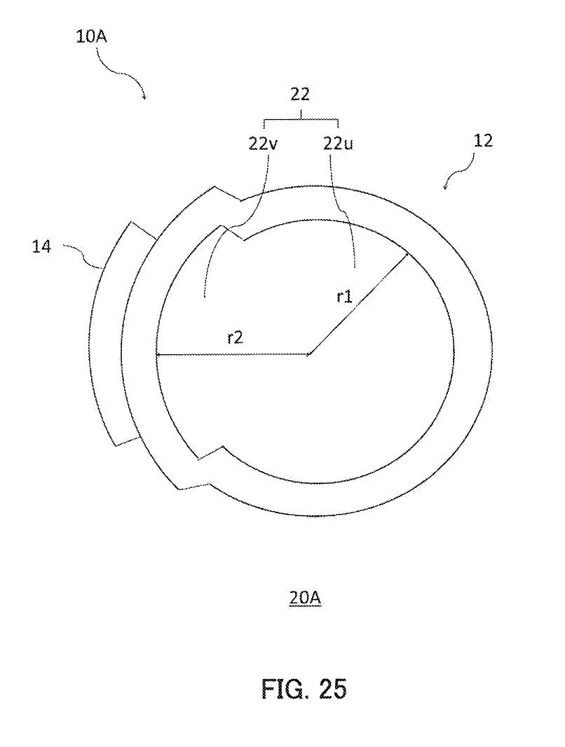

FIG. 25 is a schematic diagram showing a transfer roll 20A. Here, the thicknesses of a base 12 and a blanket 14 are almost constant, and steps are formed on the outer peripheral surface 22t of a core 22. Specifically, the core 22 includes a region 22u having a radius r1 and a region 22v having a radius r2 larger than the radius r1. The radius herein means a distance from the center of rotation to the outer peripheral surface 22t of the core 22. The blanket 14 is provided in the region 22v having the radius r2 larger than the radius r1 via the base 12 in FIG. 25. Formation of the steps on the core 22 in such a fashion can result in appropriate printing even when the recessed surface of the to-be-printed object S is comparatively deep.

It is noted that the steps are formed on the core 22 in the transfer roll 20A shown in FIG. 25, but the present invention is not limited to such a configuration. The steps may be formed on the blanket 14.

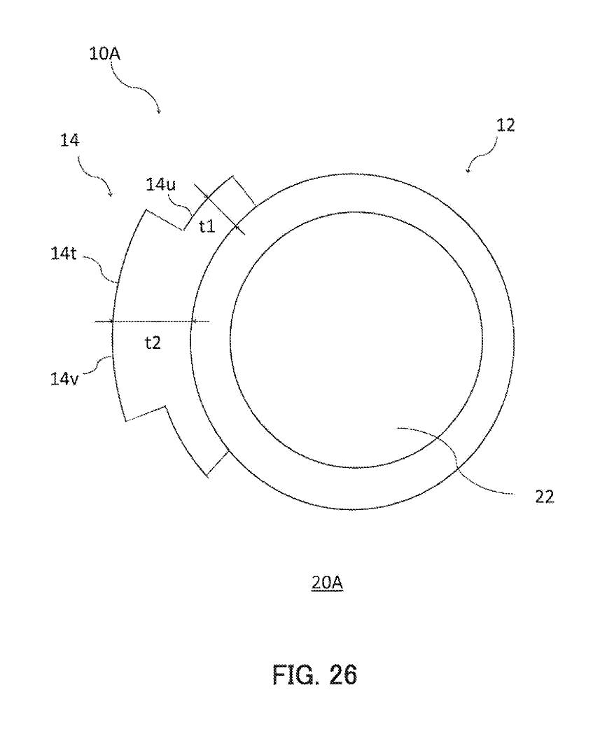

FIG. 26 is a schematic diagram showing a transfer roll 20A. Here, the thickness of a base 12 and the radius of a core 22 are almost constant, and steps are formed on the surface 14t of a blanket 14. Specifically, the blanket 14 includes a region 14u having a thickness t1 and a region 14v having a thickness t2 larger than the thickness t1. Formation of the steps on the blanket 14 in such a fashion can result in appropriate printing even when the recessed surface of the to-be-printed object S is comparatively deep.

It is noted that in each of the transfer rolls 20A shown in FIG. 24 through to FIG. 26, the steps are formed on any one of the outer peripheral surface 22t of the core 22, the outer peripheral surface 12t of the base 12, and the surface 14t of the blanket 14, but the present invention is not limited to such a configuration. Steps may be formed on any two or more of the outer peripheral surface 22t of the core 22, the outer peripheral surface 12t of the base 12, and the surface 14t of the blanket 14.

Further, the base 12 is provided between the core 22 and the blanket 14 in each of the transfer rolls 20, 20A in the above description, but the present invention is not limited to such a configuration. The blanket 14 may be provided on the core 22 without intervention by the base 12.

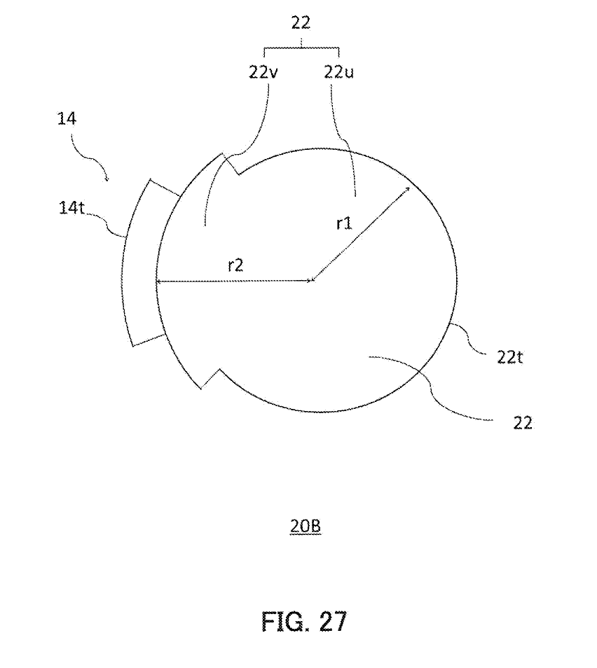

FIG. 27 is a schematic diagram showing a transfer roll 20B. The transfer roll 20B includes a blanket 14 and a core 22. Here, the blanket 14 is provided on the outer peripheral surface 22t of the core 22 and has an almost constant thickness.

Steps are formed on the outer peripheral surface 22t of the core 22 in the transfer roll 20B. Specifically, the core 22 includes a region 22u having a radius r1 and a region 22v having a radius r2 larger than the radius r1. The radius herein means a distance from the center of rotation to the outer peripheral surface 22t of the core 22. In FIG. 27, the blanket 14 is provided in the region 22v having the radius r2 larger than the radius r1. The formation of the steps on the core 22 in such a fashion can result in appropriate printing even when the recessed surface of the to-be-printed object S is comparatively deep.

It is noted that the steps are formed on the outer peripheral surface 22t of the core 22 in the transfer roll 20B shown in FIG. 27, but the present invention is not limited to such a configuration.

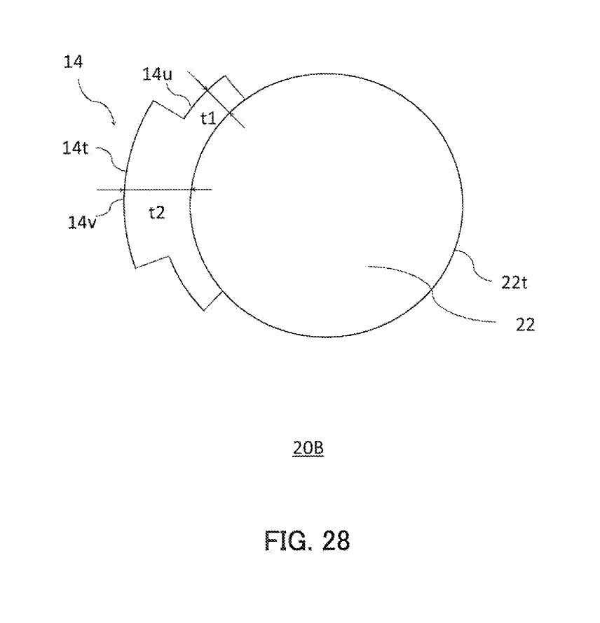

FIG. 28 is a schematic diagram showing a transfer roll 20B. Here, the radius of a core 22 is almost constant, and steps are formed on the surface 14t of a blanket 14. Specifically, the blanket 14 includes a region 14u having a thickness t1 and a region 14v having a thickness t2 larger than the thickness t1. Formation of the steps on the blanket 14 in such a fashion can result in appropriate printing even when the recessed surface of the to-be-printed object S is comparatively deep.

It is noted that the steps are formed on either one of the outer peripheral surface 22t of the core 22 and the surface 14t of the blanket 14 in the transfer rolls 20B shown in FIGS. 27 and 28, but the present invention is not limited to such a configuration. The steps may be formed on both the outer peripheral surface 22t of the core 22 and the surface 14t of the blanket 14.

Further, each of the transfer rolls 20, 20A, 20B shown in FIG. 21 through to FIG. 28 includes one blanket, which however, should not be taken to limit the present invention. A plurality of blankets 14 may be provided in any of the transfer rolls 20, 20A, 20B.

### INDUSTRIAL APPLICABILITY

According to the present invention, the blanket(s) can be replaced easily. Further, according to the present invention, appropriate printing can be performed even when the to-be-printed object S has a recessed shape.

### EXPLANATION OF REFERENCE CHARACTER

10 blanket set
12 base
12a base portion
14 blanket
20 transfer roll
22 core
100 printing machine
200 printing apparatus

1-14. (canceled)

15. A blanket set used in an offset printing apparatus in which ink is transferred from a pattern roll to a blanket of a transfer roll, followed by transfer of the ink from the blanket to a recessed surface of a to-be printed object, comprising:
a base including a plurality of base portions each having an arc shape in cross section and each attachable to and detachable from a rotatable core; and
a blanket provided on an outer peripheral surface of at least one base portion of the plurality of base portions,
wherein the at least one base portion is removable from the core together with the blanket in an integral manner, and
a step is formed on at least one of the outer peripheral surface of the at least one base portion and a surface of the blanket to increase by the step a distance from a portion of the surface of the blanket which performs printing on the recessed surface to a center of the core.

16. The blanket set of claim 15, wherein
an inner peripheral surface of the at least one base portion has a central angle of 180 degrees or smaller.

17. The blanket of claim 15, wherein
the blanket is provided on each of the plurality of base portions.

18. The blanket set of claim 15, wherein
the blanket is bonded to the at least one base portion using a coupling agent.

19. The blanket set of claim 15, wherein
the base is almost constant in thickness.

20. A transfer roll, comprising:
the blanket set of claim 15; and
a core having an outer peripheral surface corresponding to an inner peripheral surface of the base of the blanket set.

21. The transfer roll of claim 20, wherein
a through hole is formed in the at least one base portion, and
the blanket set is fixed to the core by means of a fixing member provided in the through hole.

22. The transfer roll of claim 20, wherein
a protrusion is formed on one of the inner peripheral surface of the base and the outer peripheral surface of the core, while a recess corresponding to the protrusion is formed in the other.

23. An offset printing apparatus, comprising:
the transfer roll of claim 20; and
a pattern roll.

24. The offset printing apparatus of claim 23, wherein
the transfer roll and the pattern roll each are columnar or cylindrical in shape, and
the transfer roll has a diameter that is an integral multiple of a diameter of the pattern roll.
